(19) United States
(12) Patent Application Publication
(10) Pub. No.: US 2004/0088274 A1
(43) Pub. Date: May 6, 2004

(54) Semantic hashing

(76) Inventors: Zhichen Xu, Sunnyvale, CA (US); Mallik Mahalingam, Sunnyvale, CA (US); Chunqiang Tang, Rochester, NY (US)

Correspondence Address: HEWLETT-PACKARD COMPANY, Intellectual Property Administration, P.O. Box 272400, Fort Collins, CO, 80527-2400, US

(21) Appl. No.: 10/284,095

(22) Filed: Oct. 31, 2002

(51) Int. Cl. G06F 7/00

(52) U.S. Cl. 707/1

(57) ABSTRACT

A semantic hashing method is performed in a file system. The semantic hashing method includes determining first semantic information for a first file and selecting a base file using the first semantic information and base semantic information. The base semantic information is semantic information for the base file. The method further includes computing a diff for the first file and the base file.

### CROSS-REFERENCE

The present invention is related to pending:

U.S. application Ser. No. ______, (Attorney Docket No. 200207181-1) filed herewith, and entitled “SEMANTC FILE SYSTEM”, by Xu et al.; and

U.S. application Ser. No. ______, (Attorney Docket No. 200207183-1) filed herewith, and entitled “SNAPSHOT OF A FILE SYSTEM” by Mahalingam et al.; which are all assigned to the assignee and are incorporated by reference herein in their entirety.

### FIELD OF THE INVENTION

The invention is generally related to file systems. More particularly, the invention is related to semantic file systems.

### BACKGROUND OF THE INVENTION

Fundamentally, computers are tools for helping people with their everyday activities. Processors may be considered as extensions to our reasoning capabilities and storage devices may be considered as extensions to our memories. File systems, including distributed file systems, are typically provided for accessing data organized in a hierarchal namespace, such as a directory tree, on storage devices, but the gap between the human memory and the simple hierarchical namespace of existing file systems makes these file systems hard to use.

The human brain typically remembers objects based on their contents or features. For example, when you run into an acquaintance, you may not remember the person's name, but you may recognize the person by features, such as a round face and a shiny smile. These identifying features are known as semantics or semantic information.

To bridge the gap between the human memory and the hierarchical namespace of existing file systems, people have used either separate tools or file systems that integrate rudimentary search capabilities. Tools such as GREP and other local search engines have to exhaustively search every document to match a pattern for identifying a document.

Some known semantic file systems, such as Semantic File System (SFS) and Hierarchy and Content (HAC), organize a namespace by executing queries based on semantic information and constructing the namespace with the results of the queries. For example, a directory in HAC may be created with all files that match the results of a query. These file systems, however, provide only simple keywords-based searches, and these file systems do not maintain any indices for minimizing retrieval times.

Also, known semantic file systems do not typically support archival functions, such as versioning. Generally, the most arduous task in restoring a backed up version is to find the desired file and the desired version of the file. Currently, the only way to locate the version is by remembering the date that the version was produced. In many cases, people are interested in files produced by other people, and are interested in versions with certain features. For example, in a digital movie studio an artist may make many variations of video clips. To produce a video clip, the artist may perform several editing iterations until the clip has the desired look and feel of the artist. In the process, the artist may go back to one or more previous versions, which may not be the latest version. Also, the artist may need to incorporate scenes produced by other artists, but the artist may not know the file name or correct version of the file including scenes to be incorporated. Instead, the only thing the artist may know is that these files have certain semantics. This situation arises in a variety of applications and environments, including universities, research laboratories, and medical institutions, etc.

### SUMMARY OF THE INVENTION

According to an embodiment of the invention, a semantic hashing method in a file system comprises determining first semantic information for a first file; selecting a base file using the first semantic information and base semantic information, wherein the base semantic information is semantic information for the base file; and computing a diff between the first file and the base file.

According to another embodiment of the invention, an apparatus in a file system comprises means for determining first semantic information for a first file; means for selecting a base file using the first semantic information and base semantic information, wherein the base semantic information is semantic information for the base file; and means for computing a diff between the first file and the base file.

According to yet another embodiment of the invention, a distributed file system comprises a plurality of nodes storing objects, wherein at least one of the objects is a version of a base object. One of the plurality of nodes is operable to store a diff for the version and the base object in one of the plurality of nodes. The base object is semantically close to the version. The system also comprises at least one extractor operable to extract semantic information for one or more of the objects and a semantic catalogue stored in the file system, the semantic catalogue comprising semantic information for the objects.

According to yet another embodiment of the invention, a node in a semantic-based distributed file system, the node comprises a processor; and at least one storage device storing objects and a semantic catalogue containing semantic information for the objects. The processor is operable to compute a diff between a base object in the file system and a new version of the base object for storage in the file system, the base object being semantically close to the new version.

### BRIEF DESCRIPTION OF THE DRAWINGS

The present invention is illustrated by way of example and not limitation in the accompanying figures in which like numeral references refer to like elements, and wherein:

FIG. 1A illustrates a semantic-based system, according to an embodiment of the invention;

FIG. 1B illustrates a layer view of a system architecture of the system shown in FIG. 1A;

FIG. 2 illustrates a semantic catalogue, according to an embodiment of the invention;

FIG. 3 illustrates a flow diagram of a method for searching a semantic-based file system, according to an embodiment of the invention;

FIG. 4 illustrates a flow diagram of a method for semantic hashing, according to an embodiment of the invention; and

FIG. 5 illustrates a computer platform for a node in a P2P system, according to an embodiment of the invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

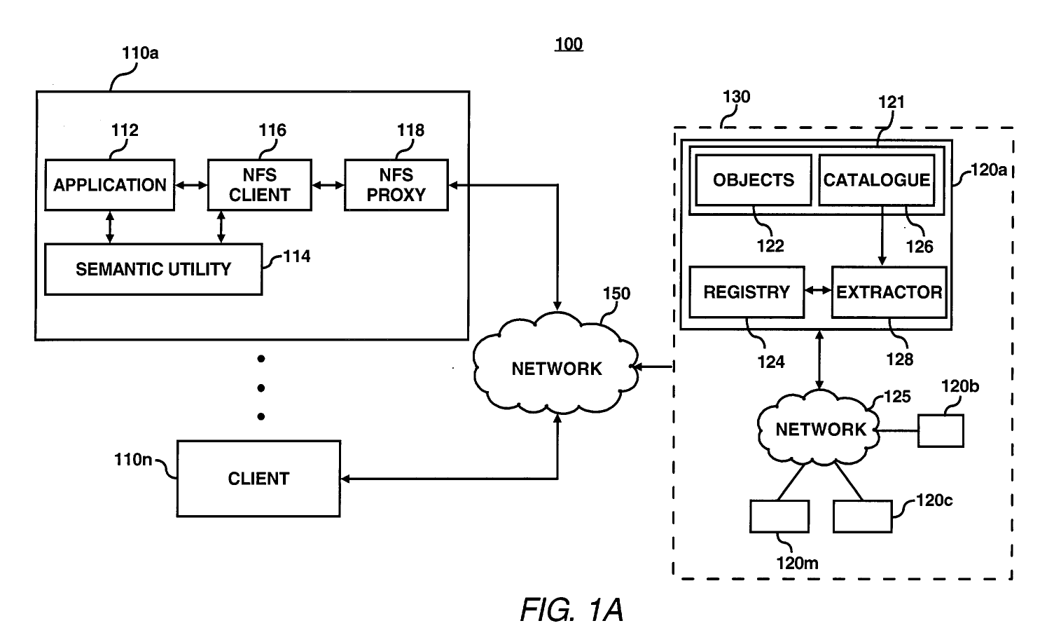

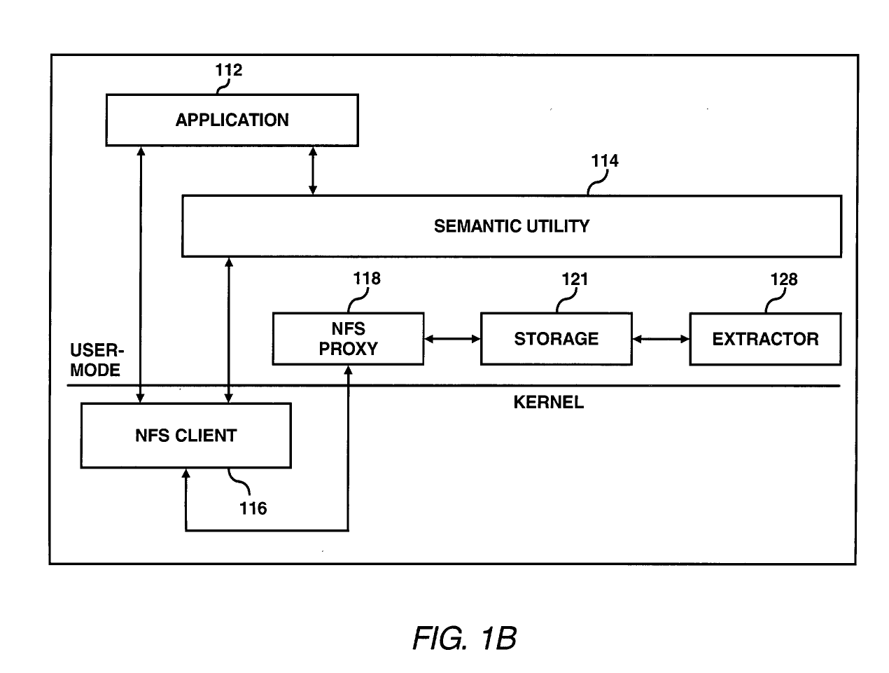

FIG. 1A illustrates an exemplary block diagram of a system 100 where an embodiment of the present invention may be practiced. It should be readily apparent to those of ordinary skill in the art that the system 100 depicted in FIG. 1 represents a generalized schematic illustration and that other components may be added or existing components may be removed or modified without departing from the spirit or scope of the present invention.

As shown in FIG. 1, the system 100 comprises a semantic archival system. The system 100 provides a semantic-based interface that allows clients to locate files according to the semantics in the files.

The system 100 includes clients 110a . . . n connected to a distributed archival file system (dafs) 130 via a network 150. According to an embodiment of the invention the dafs 130 may include a peer-to-peer (P2P) system having nodes 120a . . . m connected via a network 125. It will be apparent to one of ordinary skill in the art that a client may also be a node in the dafs 130. Furthermore, the networks 125 and 150 may include one or more of the same networks. By using a P2P system, the dafs 130 may benefit from vast storage capabilities of P2P systems, which can allow the dafs 130 to store substantially every version of an object (e.g., files, directories, documents, etc.). It will be apparent to one of ordinary skill in the art that the dafs 130 is not limited to a P2P system and may use other types of distributed systems.

In the dafs 130, each time a file is modified and closed, a new version of the file is produced. Different instances of the same file will be given a different version number. The metadata, however, may not be versioned, but the dafs 130 supports a virtual snapshotting which uses timestamps. Virtual snapshotting allows accessing the namespace arbitrarily back in time, and is described in detail in a co-pending application entitled, “Snapshot of a File System” by Mahalingam et al., and incorporated by reference above in its entirety.

The dafs 130 includes a storage 121 storing objects 122 (e.g., files, directories, etc.) and a semantic catalogue 126 including semantic vectors. The dafs 130 also includes an extractor 128, and an extractor registry 124. The semantic catalogue 126 is metadata that describes the semantics of each object 122. The semantic catalogue may be a distributed index stored in the nodes 120a . . . m. The semantic catalogue 126 contains an index of semantic vectors for objects in the dafs 130. A semantic vector includes semantic information about an object. The semantic information may be related to predetermined features that can be extracted from an object. A semantic vector may be file-type specific, such that predetermined features are extracted for each object file type. The semantic vector may include a bit wise representation in the semantic catalogue 126.

The predetermined features in a semantic vector may be extracted from an object's contents, such as features extracted from contents of a file. For example, for a text file features, such as word or term frequency information, are extracted from text documents to derive a semantic vector for the text file. Known latent semantic indexing techniques, such as matrix decomposition and truncation, may be used to extract information for creating the semantic vector. For music files, known techniques for deriving frequency, amplitude, and tempo features from encoded music data may be used to create semantic vectors. Additionally, one or more semantic vectors may be provided for other file types.

FIG. 1B illustrates a layered view of the system architecture for the system 100 shown in FIG. 1A. The application 112 and the semantic utility 114 communicate with the dafs 130 via the NFS client 116 and the NFS proxy 116. The semantic utility 114 may access the semantic catalogue 126 and the objects 122 in the storage 121 (i.e., distributed storage) of the dafs 130. The storage 122 is also connected to the extractor 128 for extracting and storing semantic vectors and performing other functions.

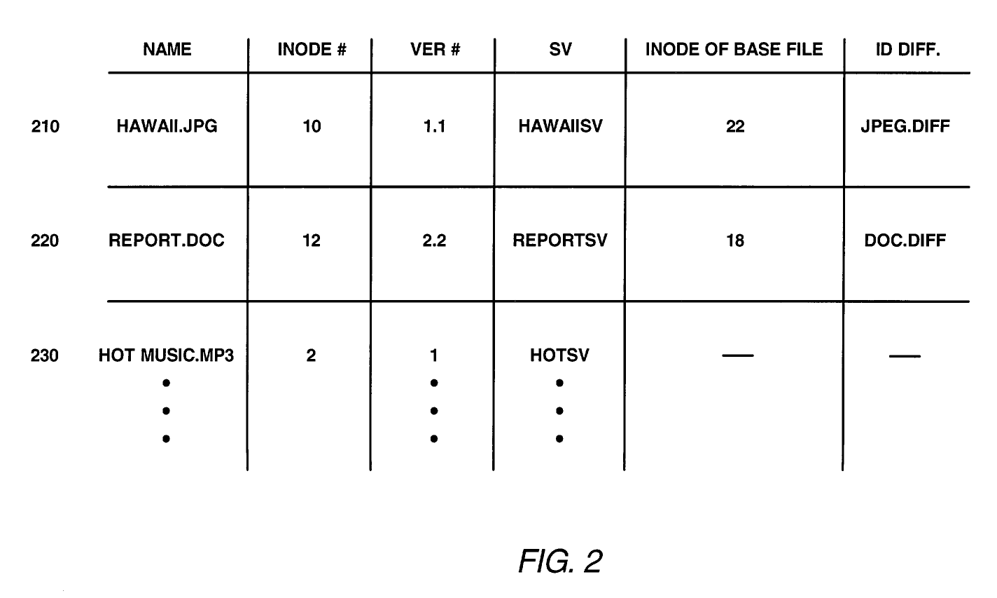

FIG. 2 generally illustrates entries in the catalogue 126 for files, wherein each version of a file has its own entry. Each directory in the dafs 130 may also include an entry, such as the name of the object, type of object and an Inode that references the object. The Inode is a unique identifier of an object in the dafs 130. An Inode in the dafs 130 is similar to an Inode in a traditional UNIX file system, however, an Inode in the dafs 130 is a unique identifier in a distributed file system. An Inode in the system 100 may include: version number, reference to the base file Inode, version number of the base file, (a “file Inode” and a “version number” may be used to uniquely identify a particular version of a file), reference to the diff, and the identifier of the function to reconstruct the file content from the base file and the diff. The storage capabilities of the P2P platform may allow for storage of substantially every version of a file and an Inode for every version. Therefore, Inodes in the system 100 may include information regarding substantially every version of a file. For each version of a file, some information needs to be stored in both the Inode and the semantic catalogue 126, such as the version number. As described above, the Inode of a directory entry may not include version information. However, a timestamp may be used to provide a snapshot of the namespace at a predetermined time. FIG. 2 illustrates entries 210-230 in the semantic catalogue 126. The fields of the catalogue 126 include, among others, file name, Inode, version number, and semantic vector. The entry 210 is for the file hawaii.jpg. It is located at Inode 10 and is version 1.1. A semantic vector HAWAIISV may be derived based on predetermined features of JPEG files. The entry 220 is for report.doc. It is located at the Inode 12 and is version 2.2. A semantic vector REPORTSV may be derived based on predetermined features of doc files. The entry 230 is for the file hot music.mp3. It is located at Inode 2 and is version 1. A semantic vector HOTSV may be derived based on predetermined features of MP3 files.

In addition to the fields described above, entries in the catalogue 126 may include fields for an Inode associated with a base file and identification (ID) of a diff. Other references, including references to the base file, the diff, and the identifier of the function to reconstruct the file content from the base and diff may be in the Inode, rather than the catalogue 126. Entries 210 and 220 each include an Inode of a base file and an ID of a diff. The entry 230 is for a new file that is not a new version.

The dafs 130 may use a diff function to derive differences between a new version and a previous version of a file. Instead of storing each new version, just the differences (i.e., a diff) between the new version and the old version are stored to conserve storage. The base file is the old version used to calculate the diff between the new version and the old version. The ID of the diff may include a reference to a simplified Inode containing a size of the diff and a pointer to the diff. The diff may be stored in the dafs 130.

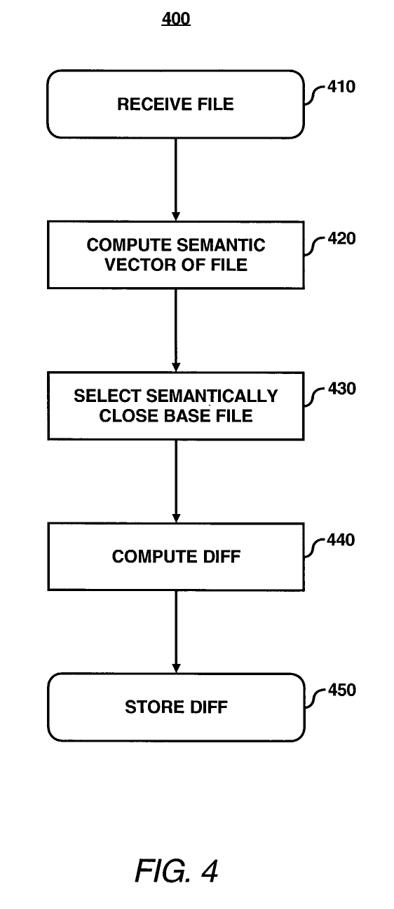

A semantic hashing technique, described with respect to FIG. 4 below, is used to locate a base file that is closest to a newly created file. Given a newly generated version of a file, its semantic vector is derived using an extractor, such as the extractor 128 of FIG. 1. By comparing the newly generated semantic vector with semantic vectors of existing files, a file that is closest to the newly generated file is located and can be used it as the base for the new file.

The diff is also used to assemble a file. For example, if the client 110a transmits a read request to the dafs 130 for Hawaii.jpg, the dafs 130 assembles Hawaii.jpg using the base file having Inode 9220 and using JPEGdiff.

The dafs 130 also includes an extractor registry 124, such as in the nodes 120a . . . m. The extractor registry 124 lists all the extractors available for creating semantic vectors. An extractor 128 is connected to the extractor registry 124. The extractor 128 may include a plug-in for creating semantic vectors. Multiple extractors, wherein each extractor may be specific to a file type, may be stored for creating semantic vectors for different file types. For data of unknown types, statistical analysis can be used to derive features from a file's bit stream. Each extractor may utilize known algorithms for extracting semantic information to create a semantic vector for a file. Both the extractor 128 and the extractor registry may include software executed at a node in the dafs 130.

A node 120a, for example, may write a new object to the storage 121. The extractor registry may be consulted to determine which extractor is used to automatically create a semantic vector for the new object. The extractor registry 124 may also provide an extensible interface that allows new extractors and diff functions to be added.

The system 100 also includes one or more of the clients 110a . . . m which perform data operations on the dafs 130. Data operations may include conventional network file system operations to access file and directory systems in the dafs 130, such as cd, Is, mkdir, mv, rm, etc. The dafs 130 also executes additional commands for executing semantic-based queries and utilizing information in the semantic catalogue 126. The clients 110a . . . m may include application(s) 12 reading/writing information to the dafs 130.

A semantic utility 114 is also included in the clients 110a . . . m. The semantic utility 114 offers semantic-based retrieval capabilities by interacting with the dafs 130. The semantic utility 114 may include a user interface allowing a user to create and execute a semantic-based query.

The semantic utility 114 interacts with the dafs 130 to generate materialized views of query results. Users can access these materialized views as regular file system objects. For example, a user can execute commands using the semantic utility 114 to create results of a query into a directory, such as using the following commands:

sdr-mkdir cn;

sdr-cp “similar to ‘hawaiijpg’” cn.

The directory cn contain links to files that are semantically close to the sample file, hawaii.jpg. Directories like “cn’ are called semantic directories, which can be accessed as a regular directory. Note that the command sdr-cp “similar to ‘hawaiijpg’” cn is a semantic-based query which can be used to view and later retrieve files similar to “hawaiijpg.”

Semantic-based queries include one or more features for identifying objects having the features. These features may be associated with one or more of the features extracted from the objects 122 to create the semantic vectors 123. Semantic-based queries can also be constrained. Typical constraints may include time and namespace. For example, a user can search for files created after Jan. 1, 1999 by issuing a command (e.g., sdr-ls “after Jan. 1, 1999”). Similarly, the user can search for files under a list of directories (e.g., sdr-ls “computer networks' under/etc, cn/; before Jan. 1, 1999”). The directories can be “semantic directories” with a hierarchal file system employed on the nodes 110a . . . 110n functioning as peers in a P2P system.

The NFS client 116 and the NFS proxy agent 118 include software allowing a user to connect to the dafs 130. The NFS client 116 provides backward compatibility for the application 112 to use the dafs 130. The NFS proxy agent accepts NFS requests and other requests specific to the dafs 130 converts the requests to a protocol understood by the dafs 130. Although not shown, the nodes 120a . . . n may include similar application program interfaces allowing the nodes 120a . . . n to execute file system commands.

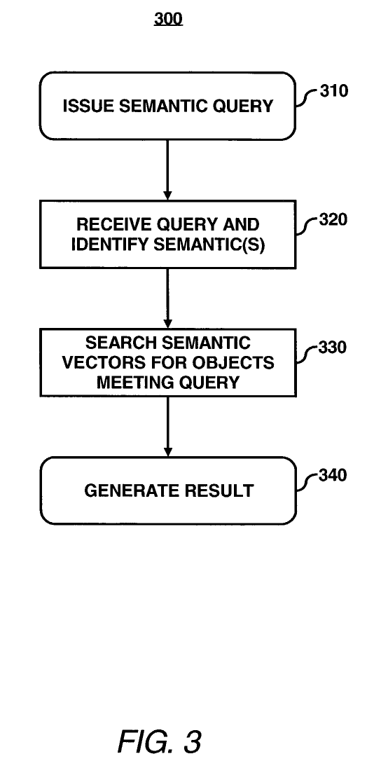

FIG. 3 illustrates a method 300 for retrieving an object using a semantic vector, according to an embodiment of the invention. In step 310 a semantic query is issued by a user which results in a search for one or more objects using one or more semantics identified from the query. For example, the command sdr-cp “similar to ‘hawaiijpg’” cn is a semantic-based query which results in a search for objects similar to Hawaii.jpg. Semantics for the search are retrieved from HAWAIISV. Another example may include a user deriving a semantic vector for a document. Then, the user uses the derived semantic vector to search for similar documents in the dafs 130.

A semantic search based on semantic vectors can be file-type specific. Generally speaking, some kind of Euclidian distance between semantic vectors of two files may be used to measure the similarity of the two files. The similarity between two files (or a query and a file) is measured as the cosine of the angle between their corresponding semantic vectors.

In step 320, the dafs receives the semantic query and identifies one or more semantics in the query. These semantics are used to search for objects in the dafs 130 having similar semantics.

In step 330, the dafs 130 searches semantic vectors in the semantic catalogue 126 to identify objects meeting the query. For example, semantic vectors are identified that have the semantics from the query.

In step 340, the dafs 130 generates a result of the search. For example, the directory cn is created including the results of the search. A user may use the semantic utility 114 to view results of a query. Steps for generating the result may also include identifying at least one object from the catalogue meeting the query; identifying location of the object from the semantic catalogue; and retrieving the object from the location for transmission to the client.

FIG. 4 illustrates a method 400 for semantic hashing, according to an embodiment of the invention. As described above with respect to the catalogue 126 shown in FIG. 2, the dafs 130 may store multiple versions of a file and the catalogue 126 may include an entry for each version. Instead of storing an entire file for each version, a diff is stored for each version. To minimize the size of the diff, thus minimizing storage consumption, a diff is generated from a base file that is closest in content to the new version.

With semantic hashing, a semantic vector for the new version is used to identify a base file having a close semantic vector. If two file are close to each other in semantics, then there is a large likelihood that the files are also close to each other in contents. Document ranking algorithms may be used to perform localized refinement for further differentiating documents in dense clusters, to consider order and distances among terms in the documents, or to use semantic-hashing together with block-level content hashing.

In step 410 of the method 400, the dafs 130 receives a new version of a file. A semantic vector is generated for the file using the extractor registry 124 and the extractor 128 associated with the file type of the new version (step 420).

In step 430, a base file semantically close to the new version is selected. Several techniques may be used to identify the base file. In one embodiment, steps 320-340 of the method 300 are used to identify multiple files that are semantically close to the new version. The multiple files are compared to the new version using a diff function. The file producing the smallest diff is selected as the base file. If the size of the diff is greater than a predetermined threshold, the process may be repeated with a new set of files. In another embodiment, block-level content hashing may be used for comparing blocks of each of the multiple files to the new version.

In step 440, a diff is computed for the new version using the base file. For example, a diff function may be selected for the file type and used to compute the diff. The computed diff is stored in the dafs 130 (step 450). An entry in the catalogue 126 is created for the new version including the Inode of the base file and the diff ID.

The new version may be created by the dafs 130 using the diff and the diff function. Applying the diff to the base file using the diff function produces an entire file, which is the new version.

The steps of the methods 300 and 400 may be performed by one or more computer programs. The computer programs may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be operable to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

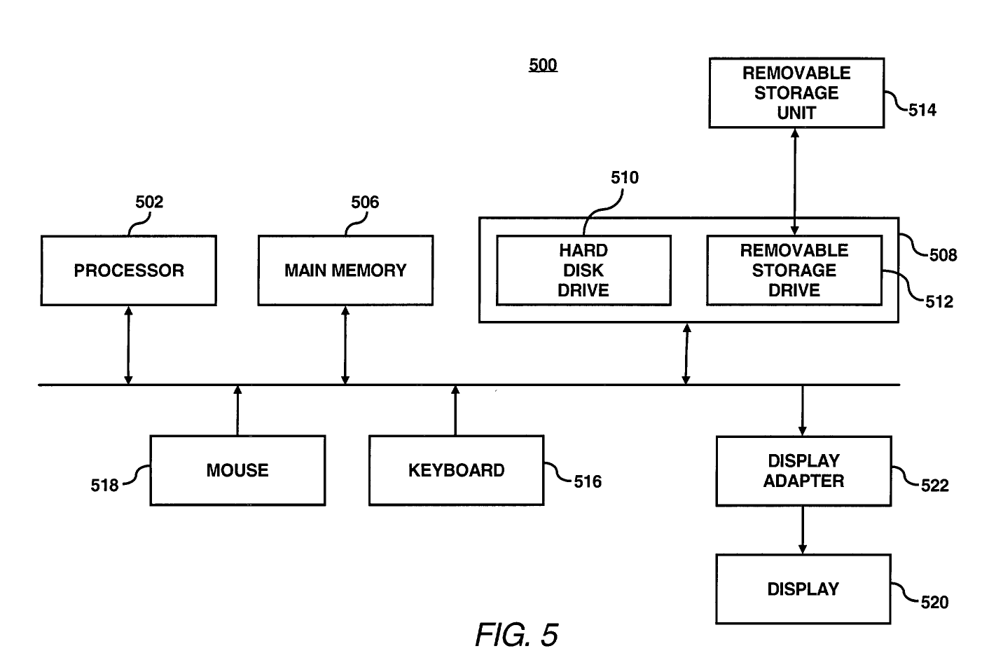

FIG. 5 illustrates an exemplary computer platform 500, according to an embodiment of the invention, for any of the nodes 120a . . . m or any of the clients 110a . . . n. The platform includes one or more processors, such as the processor 502, that provide an execution platform for software. The software, for example, may execute the steps of the method 500, perform standard P2P functions, etc. Commands and data from the processor 502 are communicated over a communication bus 504. The platform 500 also includes a main memory 506, such as a Random Access Memory (RAM), where the software may be executed during runtime, and a secondary memory 508. The secondary memory 508 includes, for example, a hard disk drive 510 and/or a removable storage drive 512, representing a floppy diskette drive, a magnetic tape drive, a compact disk drive, etc., where a copy of a computer program embodiment for the peer privacy module may be stored. The removable storage drive 512 reads from and/or writes to a removable storage unit 514 in a well-known manner. A user interfaces may interface with the platform 500 with a keyboard 516, a mouse 518, and a display 520. The display adaptor 522 interfaces with the communication bus 504 and the display 520 and receives display data from the processor 502 and converts the display data into display commands for the display 520.

While this invention has been described in conjunction with the specific embodiments thereof, it is evident that many alternatives, modifications and variations will be apparent to those skilled in the art. There are changes that may be made without departing from the spirit and scope of the invention.

What is claimed is:

1. A semantic hashing method in a file system, the method comprising:
determining first semantic information for a first file;
selecting a base file using the first semantic information and base semantic information, wherein the base semantic information is semantic information for the base file; and
computing a diff between the first file and the base file.

2. The method of claim 1, further comprising storing the diff, wherein the diff is used to generate the first file at a later time.

3. The method of claim 2, further comprising generating the first file from the stored diff in response to receiving a read request for the first file.

4. The method of claim 1, wherein the step of determining first semantic information further comprises:
extracting semantic information from the first file, the extracted semantic information including predetermined features of the first file.

5. The method of claim 1, wherein the step of selecting a base file comprises steps of:
identifying multiple files in the file system having semantic information similar to the first semantic information;
computing a diff for each of the multiple files using the first file; and
selecting a file of the multiple files having a smallest diff.

6. The method of claim 5, wherein the step of selecting a file comprises steps of:
comparing the diff of the selected file to a threshold;
selecting the file to be the base file in response to the diff being greater than the threshold; and
identifying another set of multiple files from the file system for selecting a base file in response to the diff being less than the threshold.

7. The method of claim 1, wherein the step of selecting a base file comprises steps of:
identifying multiple files in the file system having semantic information similar to the first semantic information;
performing block-level hashing for each of the multiple files and the first file; and
selecting a file of the multiple files having a most number of similar blocks to the first file.

8. The method of claim 1, wherein the step of computing the diff comprises steps of:
selecting a diff function associated with the type of the first file; and
computing the diff using the selected diff function.

9. An apparatus in a file system comprising:
means for determining first semantic information for a first file;
means for selecting a base file using the first semantic information and base semantic information, wherein the base semantic information is semantic information for the base file; and
means for computing a diff between the first file and the base file.

10. The apparatus of claim 9, further comprising means for storing the diff, wherein the diff is used to generate the first file at a later time.

11. The apparatus of claim 10, further comprising means for generating the first file from the stored diff in response to receiving a read request for the first file.

12. The apparatus of claim 9, wherein the means for determining first semantic information further comprises means for extracting semantic information from the first file, the extracted semantic information including predetermined features of the first file.

13. The apparatus of claim 9, wherein the means for selecting a base file comprises:
means for identifying multiple files in the file system having semantic information similar to the first semantic information;
means for computing a diff for each of the multiple files using the first file; and
means for selecting a file of the multiple files having a smallest diff.

14. The apparatus of claim 13, wherein the means for selecting a file comprises:
means for comparing the diff of the selected file to a threshold;
means for selecting the file to be the base file in response to the diff being greater than the threshold; and
means for identifying another set of multiple files from the file system for selecting a base file in response to the diff being less than the threshold.

15. The apparatus of claim 9, wherein the means for selecting a base file comprises:
means for identifying multiple files in the file system having semantic information similar to the first semantic information;
means for performing block-level hashing for each of the multiple files and the first file; and
means for selecting a file of the multiple files having a most number of similar blocks to the first file.

16. The apparatus of claim 9, wherein the means for computing the diff comprises:
means for selecting a diff function associated with the type of the first file; and
means for computing the diff using the selected diff function.

17. A distributed file system comprising:
a plurality of nodes storing objects, wherein at least one of the objects is a version of a base object; one of the plurality of nodes being operable to store a diff for the version and the base object in one of the plurality of nodes, wherein the base object is semantically close to the version;
at least one extractor operable to extract semantic information for one or more of the objects; and
a semantic catalogue stored in the file system, the semantic catalogue comprising semantic information for the objects.

18. The distributed file system of claim 17, wherein the distributed file system is operable to search the semantic information in the semantic catalogue to identify the base object.

19. The distributed file system of claim 18, wherein the semantic information is semantic vectors for the objects, wherein each semantic vector identifies predetermined features for an associated object.

20. The distributed file system of claim 15, wherein the semantically close base object has a semantic vector similar to a semantic vector for the version.

21. The distributed file system of claim 17, wherein the distributed file system is overlaid on a peer-to-peer network comprising the plurality of nodes.

22. The distributed file system of claim 21, further comprising a distributed archive file system operable to store a plurality of versions of the objects.

23. The distributed file system of claim 17, wherein the semantic catalogue is a distributed index stored on the plurality of nodes.

24. The distributed file system of claim 17, wherein the diff is data associated with differences between the base object and the version.

25. A node in a semantic-based distributed file system, the node comprising:
a processor; and
at least one storage device storing objects; and
a semantic catalogue containing semantic information for the objects, wherein the processor is operable to compute a diff between a base object in the file system and a new version of the base object for storage in the file system, the base object being semantically close to the new version.
